(19) United States
(12) Patent Application Publication
(10) Pub. No.: US 2002/0094186 A1
(43) Pub. Date: Jul. 18, 2002

(54) Optical attenuator

(76) Inventor: Chi Wu, San Marino, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/765,723

(22) Filed: Jan. 18, 2001

(51) Int. Cl. G02B 6/10; G02B 6/26

(52) U.S. Cl. 385/140; 385/132

(57) ABSTRACT

An optical attenuator is disclosed. The attenuator includes a light transmitting medium having a ridge defining at least a portion of a light signal carrying region. The attenuator also includes at least one first index changing element positioned over the ridge. The at least one first index changing element is configured to change the index of refraction of the light transmitting medium.

### BACKGROUND

1. Field of the Invention

The invention relates to one or more optical networking components. In particular, the invention relates to an optical attenuator.

2. Background of the Invention

Many components for optical networking include a plurality of waveguides formed on a substrate. One or more of the waveguides often include an optical attenuator. Optical attenuators are used to reduce the intensity of the optical signals being carried by a waveguide. Many optical attenuators are controllable in that they allow the intensity of the light signals to be reduced to a desired level.

Components including optical attenuators often include a light insulator positioned over a substrate. A layer of a light transmitting medium positioned adjacent to the light insulator is formed into one or more ridges that each define a portion of a waveguide. The light insulator is a continuous layer that is positioned under each of the ridges. The light insulator prevents light that is being carried by a waveguides from leaking into the substrate.

Attenuators often include electrical contacts positioned on opposing sides of a ridge. During operation of the attenuator, a potential is applied between the contacts. The potential changes the index of refraction of the light transmitting medium between the contacts. The change in index of refraction causes light signals to be reflected out of the waveguide. Because a portion of the light signal is no longer carried within the light signal carrying region, the intensity of the light signal carried by the waveguide is reduced.

The light insulator traps the light reflected out of the waveguide in the light transmitting medium. This trapped light is able to enter other waveguides formed in the light transmitting medium. Accordingly, the optical attenuator can serve as a source of cross talk by driving light out of the light carrying regions and into other waveguides. Further, applying a potential between opposing sides of the ridge, causes the index of refraction to be changed under the ridge but not inside of the ridge. As a result, the index of refraction does not change in a large cross section of the waveguide resulting in a low attenuation efficiency.

For the above reasons, there is a need for an optical attenuator that is not associated with increased cross talk. There is also a need for an optical attenuator that is more efficient.

### SUMMARY OF THE INVENTION

The invention relates to an optical attenuator. The attenuator includes a light transmitting medium having a ridge defining at least a portion of a light signal carrying region. The attenuator also includes at least one first index changing element positioned over the ridge. The at least one first index changing element is configured to change the index of refraction of the light transmitting medium.

Another embodiment of the optical attenuator includes a waveguide formed over a substrate. At least one first index changing element is positioned over the waveguide. At least one first index changing element is configured to change the index of refraction of the light transmitting medium.

Yet another embodiment of the optical attenuator includes a light signal carrying region defined in a light transmitting medium. The light signal carrying region has one or more sides extending along a longitudinal length of the light signal carrying region. Two or more index changing elements are positioned adjacent to the same side of the light signal carrying region. The index changing elements are configured to change the index of refraction of the light transmitting medium.

Yet another embodiment of the attenuator includes a light barrier having a surface between sides. A first light transmitting medium is positioned adjacent to the surface of the light barrier. The surface of the light barrier defines a portion of a light signal carrying region in the first light transmitting medium. A second light transmitting medium is positioned adjacent to the sides of the light barrier. The attenuator also includes at least one index changing element for changing the index of refraction of the first light transmitting medium. The at least one index changing element is positioned such that light signals are diverted from the light signal carrying region in response to employing the index changing element to change the index of refraction of the first light transmitting medium.

The invention also relates to a method for forming an optical attenuator. The method includes obtaining a light transmitting medium having a ridge that defines at least a portion of a light signal carrying region in the light transmitting medium. The method also includes positioning at least one first index changing element over the ridge. The at least one first index changing element is configured to change the index of refraction of the light transmitting medium.

Another embodiment of the method includes obtaining a light transmitting medium having a light signal carrying region with sides extending along a longitudinal length of the light signal carrying region. The method also includes positioning two or more index changing elements adjacent to the same side of the light signal carrying region. The two or more index changing elements are configured to change the index of refraction of the light transmitting medium.

Yet another embodiment of the method includes obtaining a first light transmitting medium having a light signal carrying region with a surface between sides. The first light transmitting medium is produced such that the first light transmitting medium is adjacent to the surface of the light barrier and a second light transmitting medium is adjacent to at least one side of the light barrier. The method also includes positioning at least one index changing element such that light signals are diverted from the light signal carrying region in response to operating the at least one index changing element so as to change the index of refraction of the first light transmitting medium.

A further embodiment of the method includes obtaining an optical component having a waveguide formed over a substrate. The method also includes forming at least one first index changing element over the waveguide. The at least one first index changing element is configured to for change the index of refraction of the light transmitting medium.

In the methods described above, the acts of obtaining a light transmitting medium; obtaining a first light transmitting medium; or obtaining an optical component can include receiving these items from a supplier or fabricating these items.

### BRIEF DESCRIPTION OF THE FIGURES

FIG. 1A illustrates a cross section of a component having a waveguide including an optical attenuator.

FIG. 1B is a cross section of the optical attenuator illustrated in FIG. 1A.

FIG. 2A illustrates a light signal traveling through the optical attenuator.

FIG. 2B illustrates the light signal of FIG. 2A being attenuated.

FIG. 3A illustrates a cross section of another embodiment of a component having a waveguide and an optical attenuator.

FIG. 3B is a cross section of the component illustrated in FIG. 3A taken along the line labeled C.

FIG. 3C is a cross section of the component illustrated in FIG. 3A taken along the line labeled D.

FIG. 4A illustrates an embodiment of a component having index changing elements on opposing sides of the component. The component includes a light barrier that conducts current.

FIG. 4B illustrates an embodiment of a component having index changing elements on opposing sides of the component. The component includes a light barrier that insulates current.

FIG. 5A is a topview of a component having a plurality of index changing elements positioned adjacent to the same side of a waveguide. An index changing element is positioned between the waveguide and another index changing element.

FIG. 5B is a cross section of the component shown in FIG. 5A taken at the line labeled A.

FIG. 5C is a topview of a component having a plurality of index changing elements positioned adjacent to the same side of a waveguide. The index changing elements are positioned in a line that is substantially parallel to the waveguide.

FIG. 5D is a cross section of the component shown in FIG. 5C taken at the line labeled A.

FIG. 6A is a cross section of a component having a single index changing element positioned over a ridge.

FIG. 6B is a cross section of a component having a single index changing element positioned adjacent to a side of the ridge.

FIG. 7A illustrates an embodiment of an attenuator with a first index changing element positioned adjacent to a first side of a ridge and a second index changing element positioned adjacent to a second side of the ridge. A light barrier does not extend under the first index changing element and the second index changing element.

FIG. 7B illustrates an embodiment of an attenuator with a first index changing element positioned adjacent to a first side of a ridge and a second index changing element positioned adjacent to a second side of the ridge. A light barrier extends under the first index changing element and the second index changing element.

FIG. 8A through FIG. 8F illustrate attenuators having more than two index changing elements.

FIG. 9A through FIG. 9F illustrate a method for forming a component having an optical attenuator.

FIG. 10A through FIG. 10F illustrate another embodiment of a method for forming a component having an optical attenuator.

### DETAILED DESCRIPTION OF THE PREFERRED EMBODIMENT

The invention relates to an attenuator having a light transmitting medium formed into a ridge. The ridge is positioned over a light barrier. The ridge and the light barrier each define a portion of a light signal carrying region. At least one index changing element is positioned over the ridge. Another index changing element can be positioned under the ridge or adjacent to the ridge. The index changing elements are configured to change the index of refraction of the light transmitting medium.

In some instances, the index changing elements are configured to change the index of refraction of the light transmitting medium positioned between the index changing elements. When one index changing element is positioned over the ridge and another positioned adjacent to the ridge or below the ridge, the index of refraction is changed in the ridge as well as below the ridge. Accordingly, the index of refraction is changed throughout a large portion of the light signal carrying region. The change in index of refraction is responsible for light signals being reflected out of the light signal carrying region. Accordingly, the change in the index of refraction is responsible for attenuation of the light signals. Because the index of refraction is changed through a large region of the light signal carrying region, the attenuation of the light signals is efficient.

In one embodiment, the light barrier includes a surface positioned between two sides. The surface of the light barrier defines a portion of the light signal carrying region. In one embodiment a second light transmitting medium is positioned adjacent to the sides of the light barrier. The barrier can be sized such that at least a portion of the light reflected out of the light signal carrying region, i.e. attenuated, passes through the second light transmitting medium. Accordingly, the second light transmitting medium serves as a drain for light reflected out of the light signal carrying region. The drained light can enter a substrate and/or exit from the component. As a result, the drained light is less likely to be a source of cross talk by entering other waveguides and/or attenuators on the component.

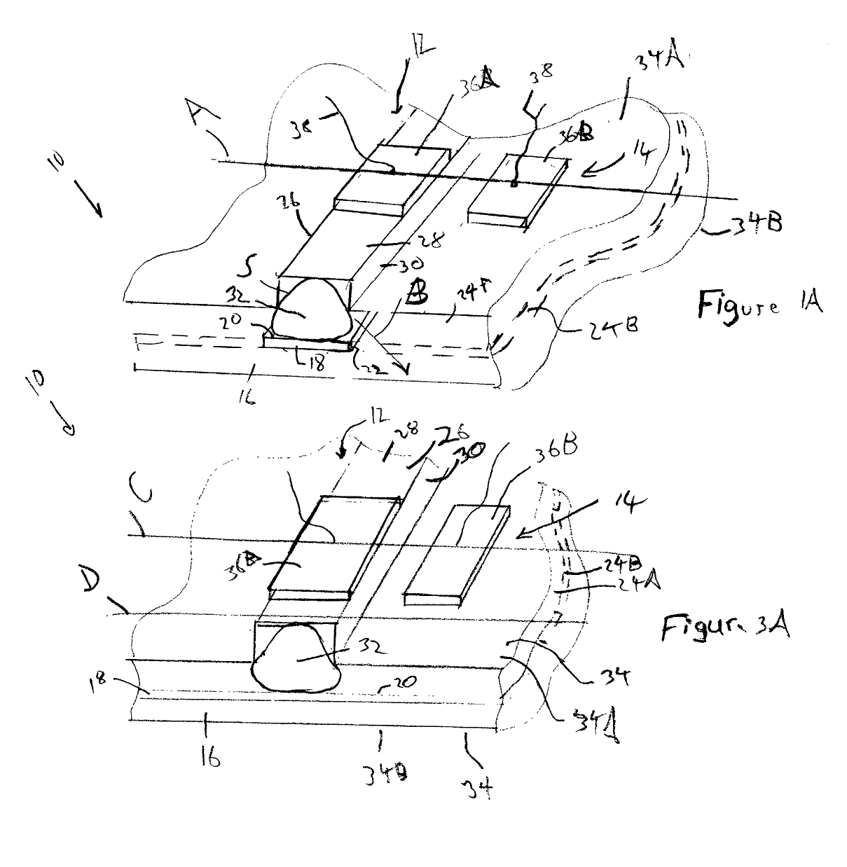

FIG. 1A illustrates a cross section of a component 10 having a waveguide 12 and an optical attenuator 14. The component 10 includes a substrate 16. A light barrier 18 is formed over the substrate 16. The light barrier 18 has a surface 20 between two sides 22. A second light transmitting medium 24B is positioned adjacent to the sides 22 of the light barrier 18. A first light transmitting medium 24A is positioned over the second light transmitting medium 24B and the light barrier 18.

The first light transmitting medium 24A is formed into a ridge 26 having sides extending along a longitudinal length of the ridge. The sides include a top 28 and lateral sides 30. A light signal carrying region 32 is formed between the ridge and the light barrier 18. The light barrier defines a portion of the light signal carrying region and the ridge defines another portion of the light signal carrying region 32. The sides of the ridge serve as sides of the waveguide and the light signal carrying region 32. A profile of a light signal traveling along the light signal carrying region 32 is shown by the line labeled S.

A first index changing element 36A is positioned over the ridge 26 and a second index changing element 36B is positioned adjacent to a side 30 of the ridge 26. Electrical conductors 38 such as wires can optionally be connected to the index changing elements 36 for application of a potential between the index changing elements 36. As will be discussed in more detail below, the index changing elements 36 are configured to change the index of refraction of the light transmitting medium. Additionally, the index changing elements are positioned so the change in the index of refraction diverts light signals from the light signal carrying region.

FIG. 1B is a cross section of the attenuator 14 illustrated in FIG. 1A taken at the line labeled A. A doped region 40 is formed adjacent to each of the index changing elements 36. The doped regions 40 can be N-type material or P-type material. When one doped region 40 is an N-type material, the other doped region 40 is a P-type material. For instance, the doped region adjacent to the first index changing element can be a P type material while the material adjacent to the second index changing element can be an N type material.

The second light transmitting medium 24B is positioned to receive at least a portion of the light that is diverted from the light signal carrying region 32. The light received by the second light transmitting medium 24B can enter the substrate 16 as shown by the arrow labeled B. Accordingly, the second light transmitting medium 24B serves to drain light reflected out of the light signal carrying region 32 from a waveguide 12 and/or from the component 10. Because the light is drained from the component 10, the light represented by the arrows labeled B does not enter adjacent waveguides 12 and accordingly does not result in cross talk.

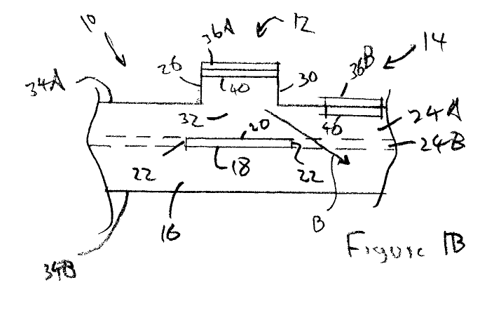

FIGS. 2A and 2B illustrate operation of the component 10 illustrated in FIG. 1A and FIG. 1B. FIG. 2A illustrates a light signal being carried in the light signal carrying region 32. During operation of the attenuator 14, a potential is applied between the index changing elements 36. The potential causes the index of refraction of the first light transmitting medium positioned between the index changing elements to change as shown by the lines 44.

When the potential on the index changing element adjacent to the P-type material is less than the potential element on the index changing element adjacent to the N-type material, a current flows through the light transmitting medium and the index of refraction decreases. The reduced index of refraction causes at least a portion of the light signals to be reflected out of the light signal carrying region. Because the light signals are reflected out of the light signal carrying region 32, the light signal carrying region 32 carries a reduced portion of the light signals. As a result, a light signal exiting the attenuator 14 has less intensity than the light signal that entered the attenuator 14.

When the potential on the index changing element adjacent to the P-type material is greater than the potential element on the index changing element adjacent to the N-type material, an electrical field is formed between the index changing elements and the index of refraction increases. The light signals are drawn to the region of increased index of refraction. Accordingly, this arrangement can serve to increase the retention of light signals in the light signal carrying region.

The substrate 16, the first light transmitting medium 24A and the second light transmitting medium 24B can be formed of the same or different materials. For instance, the substrate 16, the first light transmitting medium 24A and the second light transmitting medium 24B can all be silicon while the light barrier 18 is air or silicon dioxide. Further, the substrate 16 can be silicon, the first light transmitting medium 24A can be GaAs, InP, SiGe or silicon and the second light transmitting medium 24B can be GaAs, InP, SiGe or Silicon while the light barrier 18 is air or silicon dioxide, silicon nitride or SiONx or other material wit index of refraction lower than the first light transmitting medium. The use of GaAs allows the component 10 to be used for high speed applications. Additionally, the substrate 16, the first light transmitting medium 24A and the second light transmitting medium 24B can be InP and the light barrier 18 can be InGaAs.

When the first light transmitting medium is Silicon, the light barrier can be silicon dioxide or SiNx or other materials with an index of refraction lower than Silicon. The function of the light barrier is to reduce or prevent light from the light signal carrying region from leaking into the substrate. In some embodiments, the light barrier 18 can have reflective properties such as a metal layer or a metal coating for applications where the optical losses caused by metals are not at issue. Alternatively, the light barrier 18 can be a material that transmit light but causes light reflection at the intersection of the light barrier 18 and the first light transmitting medium 24A. This light reflection can result from a change in the index of refraction between the light barrier 18 and the first light transmitting medium 24A. For instance, the light barrier 18 can be silicon dioxide or air when the first light transmitting medium 24A is silicon. When the light reflection results from a change in the index of refraction, thinner light barriers will transmit more light. Additionally, increased transmission will result when the difference between the index of refraction of the light barrier and the first light transmitting medium is reduced. These variables should be adjusted to achieve the desired level of reflection by the light barrier. In most applications, it is preferred that there is as much reflection at the light barrier as is possible, i.e. that there is no leakage or substantially no leakage of light into the substrate.

The second side 34B of the component 10 can include an anti-reflective coating. The anti-reflective coating reduces reflection of light that passes through a drain back into the component 10. Accordingly, the anti-reflective coating can increase the efficiency that light is drained from the component 10.

The periphery of the light barriers 18 can trace the periphery of the ridge 26. For instance, the distance between the periphery of the light barrier 18 and the periphery of the ridge 26 can be substantially constant.

The light barrier 18 is sized such that at least a portion of the light that escapes the light signal carrying region 32 can pass adjacent to the side 22 of the light barrier 18 and into the substrate 16. As shown in FIG. 1A and FIG. 1B, the light barrier 18 and waveguide 12 can be constructed such that the periphery of the light barrier 18 extends beyond the periphery of the ridge 26 of the waveguide 12. In some instances, the light barrier 18 and waveguide 12 are constructed such that the periphery of the light barrier 18 is substantially the same size as the ridge 26 of the waveguide 12.

In other instances, the light barrier 18 and waveguide 12 are constructed such that the periphery of the light barrier 18 is smaller the ridge 26 of the waveguide 12. Having the periphery of the light barrier 18 be smaller than the periphery of the waveguide 12 is useful for when a particular amount of light signal drain is always desired. The size of the light barrier 18 periphery can be controlled to achieve a particular amount of light signal drain.

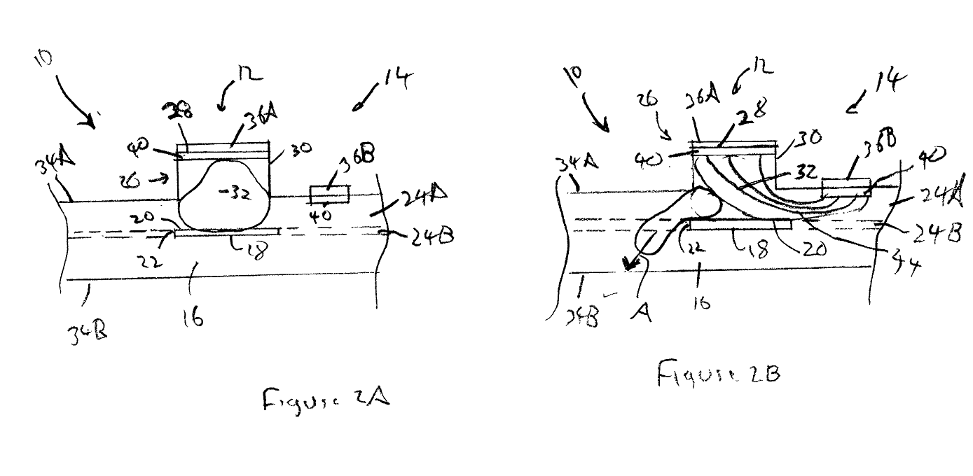

FIG. 3A is a cross section of another embodiment of the component 10. FIG. 3B is a cross section of the component 10 illustrated in FIG. 3A taken along the line labeled C and FIG. 3C is a cross section of the component 10 illustrated in FIG. 3A taken along the line labeled D. The attenuator 14 include drains while the waveguides 12 that are remote from the attenuator 14 does not include drains. Accordingly, the attenuator 14 retains the advantages of the drains.

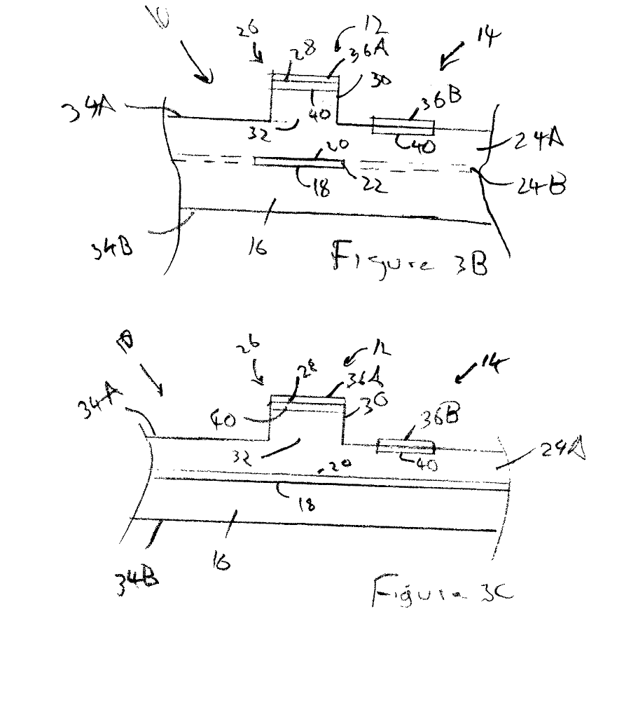

An index changing element 36 can be positioned on opposing sides 34 of the component 10 as illustrated in FIG. 4A. A first index changing element 36A is positioned over the ridge 26 and the second index changing element 36B is positioned under the ridge 26. Doped regions are illustrated adjacent to the first index changing element and the second index changing element. The doped regions 40 can be N-type material or P-type material. When one doped region 40 is an N-type material, the other doped region 40 is a P-type material. For instance, the doped region adjacent to the first index changing element can be a P type material while the material adjacent to the second index changing element can be an N type material.

Applying a potential between the index changing elements so a current flows through the component changes the index of refraction of the materials between the index changing elements as illustrated by the lines 44. Because the light barrier conducts the current, the lines extend through the light barrier. When the light barrier is less conductive to current as would result from a light barrier that includes air or silica, the index of refraction of the materials between the index changing elements changes as illustrated by the lines 44 in FIG. 4B. Additionally, the current can be spread out further through the light signal carrying region by increasing the width of the second index changing element 36B.

In some instances, the second index changing element 36B can extend under more than one waveguide having a first index changing element 36A so more than one attenuator can share the same second index changing element. A single doped region can be positioned adjacent to the second index changing element and can extend under more than one of the first index changing elements. Alternatively, a plurality of doped regions can be positioned adjacent to the second index changing element. Each of the doped regions adjacent to the second index changing element can be positioned under a different first index changing element.

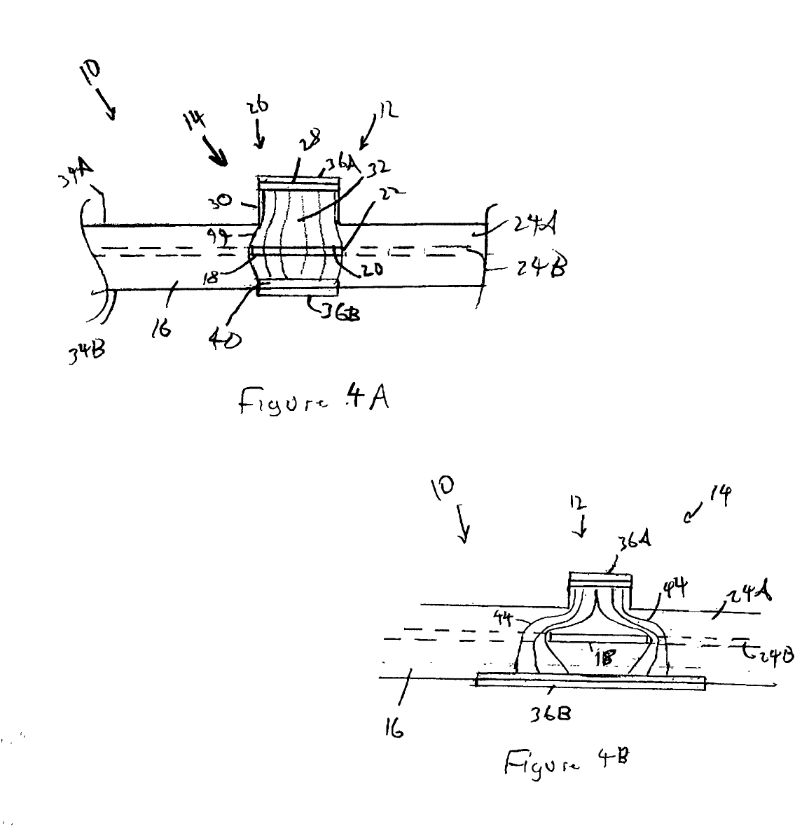

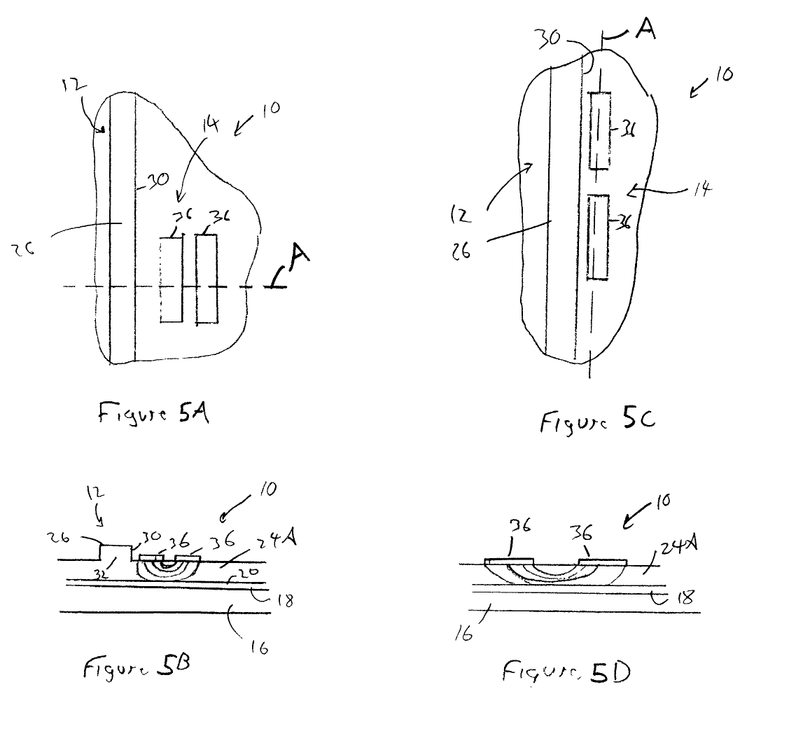

The index changing elements 36 can be positioned adjacent to the same side 30 of the ridge 26 as shown in FIG. 5A and FIG. 5B. FIG. 5A is a topview of a portion of a component 10. FIG. 5B is a cross section of the component 10 shown in FIG. 5A taken at the line labeled A. An index changing elements 36 is positioned between the ridge 26 and another index changing element 36.

Although not illustrated, the index changing elements 36 can each be positioned adjacent to doped regions. The doped regions can be a region of N-type material and/or a region of P-type material as shown in FIG. 1B. When the potential on the index changing element adjacent to the P-type material is greater than the potential element on the index changing element adjacent to the N-type material, the index of refraction of the light transmitting medium increases as shown by the lines 44. The region of increased index of refraction is adjacent to the light signal carrying region and may extend into the light signal carrying region. At least a portion of the signals in the light signal carrying region are drawn toward the region of increased index of refraction and are diverted from the light signal carrying region. Accordingly, the increased index of refraction serves to attenuate the light signals.

The doped region FIG. 5A and FIG. 5B can each include an N type material, a P type material or one can be an N type material and one can be a P type material. Alternatively, the component of FIG. 5A and FIG. 5B need not include doped regions N-type material and/or a region of P-type material. When these regions are not present and a potential is applied to the index changing elements, the temperature between the index changing elements 36 increases. The increase in temperature causes the index of refraction between the index changing elements to increase. The increased index of refraction causes the light signals in the light signal carrying region to be attenuated as described above.

The index changing elements 36 can be positioned in parallel with a side of the waveguide as illustrated in FIG. 5C and FIG. 5D. FIG. 5C is a topview of a portion of a component. FIG. 5D is a cross section of the component 10 shown in FIG. 5A taken at the line labeled A. The index changing elements 36 are positioned substantially equidistant from the waveguide 12. Applying a potential between the index changing elements 36 causes the index of refraction of the first light transmitting medium 24A between the index changing elements to be changed as shown by the lines 44.

Although the index changing elements 36 disclosed above are electrical contacts, such as ohmic contacts or Schottky contacts, one or more index changing elements 36 can be a temperature changing element such as a heater and/or cooler. Suitable heaters include resistive heaters. Another suitable temperature changing element includes a thermal conductor having one or more lumens through which a heating fluid and/or a cooling fluid can be pumped. These temperature changing elements can locally increase and/or decrease the temperature of the optical component.

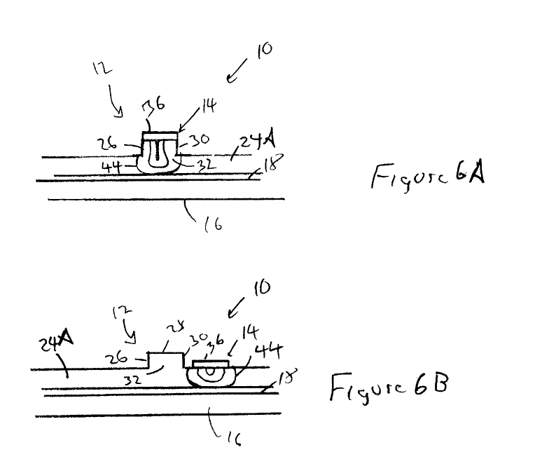

When the index changing element is a temperature changing element the attenuator can include a single index changing element as shown in FIG. 6A and FIG. 6B. FIG. 6A illustrates a single index changing element 36 positioned over a ridge 26. Decreasing the temperature of the index changing element 36 lowers the temperature of the light signal carrying region 32. The reduced temperature causes the index of refraction of the first light transmitting medium 24A to be lowered as shown by the lines 44. The reduced index of refraction causes light signals to be reflected out of the light signal carrying region 32.

FIG. 6B illustrates a single index changing element 36 positioned adjacent to a side 30 of a ridge 26. Increasing the temperature of the index changing element increases the temperature of the light transmitting medium adjacent to the light signal carrying region 32 and/or in the light signal carrying region 32. The increased temperature causes the index of refraction of the light transmitting medium to be increased as shown by the lines 44. The increased index of refraction causes light signals to be drawn out of the light signal carrying region 32 and accordingly attenuates the light signals.

Although FIG. 6A and FIG. 6B illustrate an attenuator 14 including a single temperature changing element, an attenuator can include a plurality of temperature changing elements. Each of the temperature changing elements can change the temperature independently or they can act together to change the temperature of the component. For instance, an electrical current formed between two electrical contacts can raise the temperature of the portion of the component carrying the current.

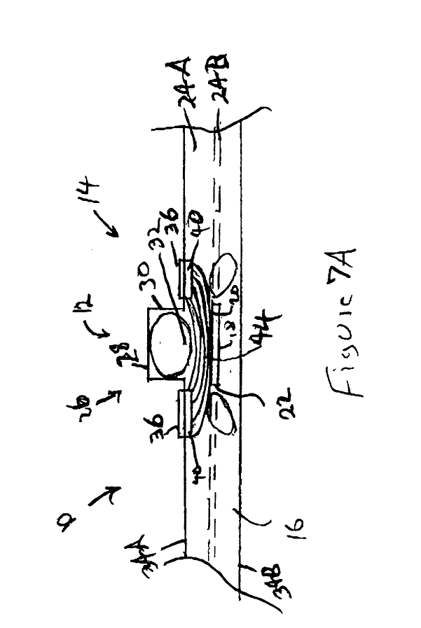

An index changing element 36 can be positioned adjacent to a side of the light signal carrying region 32 as illustrated in FIG. 7A. The first index changing element 36A is positioned adjacent to one side 30 of the ridge 26 and the second index changing element 36B is positioned adjacent to the other side 30 of the ridge 26. Applying a potential to the index changing elements 36 changes the index of refraction in the light signal carrying region 32 as illustrated by the lines 44.

Many of the component embodiments illustrated above include have a second light transmitting medium is positioned adjacent to the sides of the light barrier. Many of the embodiments illustrated above show the index changing element(s) positioned adjacent to the ridge as being positioned entirely over the second light transmitting medium. However, the index changing element(s) positioned adjacent to the ridge can be positioned entirely over the light barrier or can overlap the light barrier and the second light transmitting medium. For instance, FIG. 7B illustrates a component 10 having two index changing elements 36 positioned adjacent to the ridge 26, each of the index changing elements is positioned entirely over the light barrier 18. The index changing element(s) can be positioned over the light barrier 8 as a result of increasing the width of the light barrier or by moving the index changing element closer to the ridge.

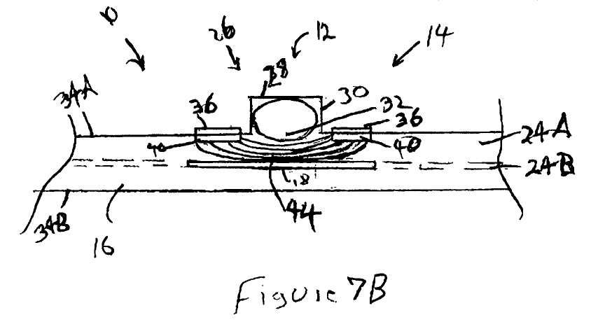

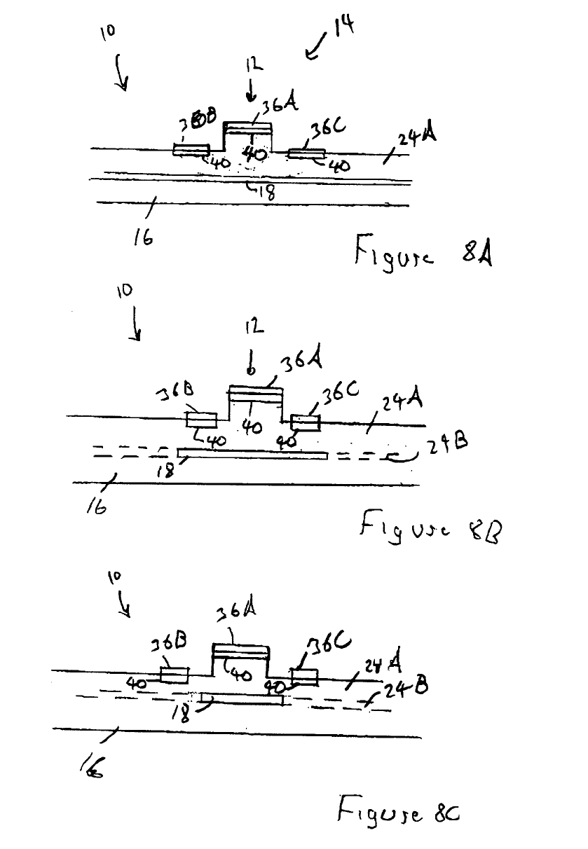

The attenuator can include more than two index changing elements. For instance, FIG. 8A through FIG. 8C illustrate a component 10 having three index changing elements 36. A first index changing element 36A is positioned over the ridge 26, a second index changing element 36B and a third index changing element 36C are positioned adjacent to the ridge 26. FIG. 8B illustrates three index changing elements 36 employed in a component 10 having a second light transmitting medium 24B positioned adjacent to the sides of a light barrier 18. The second index changing element 36B and the third index changing element 36C are positioned over the light barrier 18. The second index changing element 36B and the third index changing element 36C can be positioned over the second light transmitting medium 24B as shown in FIG. 8C.

The doped region 40 under the first index changing element 36A can be different than the doped region 40 under the second index changing element 36B and the third index changing element 36C. For instance, the doped region 40 under the first index changing element 36A can be an N type material and the other doped regions can be a P type material. Alternatively, the doped region 40 under the first index changing element 36A can be a P type material and the other doped regions 40 can be N type material as shown in FIG. 8D.

A number of different arrangements are possible for operating the attenuator of FIG. 8D to attenuate light signals. For example, a positive potential can be applied to the first index changing element 36A and negative potentials can be applied to the second index changing element 36B and the third index changing element 36C. This arrangement causes current to flow as illustrated by the lines 44. As noted above, the current flow results in a reduced index of refraction and attenuation of the light signal.

Another method of operating the component shown in FIG. 8D is illustrated in FIG. 8E. A positive potential is applied to the first index changing element 36A and the third index changing element 36C is grounded. Applying a negative potential to the second index changing element 36B causes current to flow as illustrated by the lines. The current flow reduces the index of refraction and cause attenuation of the light signals.

The doped regions 40 on opposing sides of the ridge can be different. For instance, the doped region 40 under the first index changing element 36A can be a P type material, the doped region 40 under the second index changing element 36B can be an N type material and the doped region 40 under the third index changing element 36C can be a P type material . Alternatively, the doped region 40 under the first index changing element 36A can be an N type material , the doped region 40 under the second index changing element 36B can be an N type material and the doped region 40 under the third index changing element 36C can be an P type material as illustrated in FIG. 8F.

A number of arrangements are possible for operating the component 10 in FIG. 8F so as to attenuate light signals. For example, a negative potential can be applied to the first index changing element 36A and the second index changing element 36B can be grounded to cause a low level of current low between the first index changing element 36A and the second index changing element 36B. A positive potential applied to the third index changing element 36C increases the flow of current. Accordingly, the level of potential applied to the third index changing element 36C control the current level and accordingly the attenuation level.

The first light transmitting medium in any of the attenuators described above can be undoped, doped with an N type material or doped with a P type material. Increasing the level of dopant in the first light transmitting medium can increase the efficiency of current injection through the component. However, increasing the dopant level can also result in increased optical loss. As a result, the first light transmitting medium is preferably lightly doped n material or lightly doped p material. The dopant can be localized to the area where the index of refraction is changed or where the current is injected. Alternatively, the entire first light transmitting medium can be doped. When the change in the index of refraction or current will extend into the second light transmitting medium and/or the substrate, the second light transmitting medium and/or the substrate are preferably doped similarly to the first light transmitting medium. For instance, when the attenuator is implemented as shown in FIG. 4A or FIG. 4B and the light signal carrying region is doped, the substrate is preferably also doped.

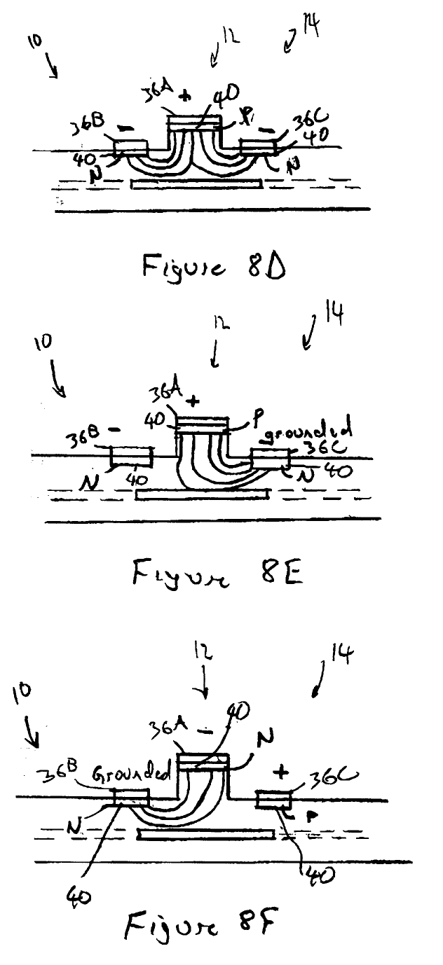

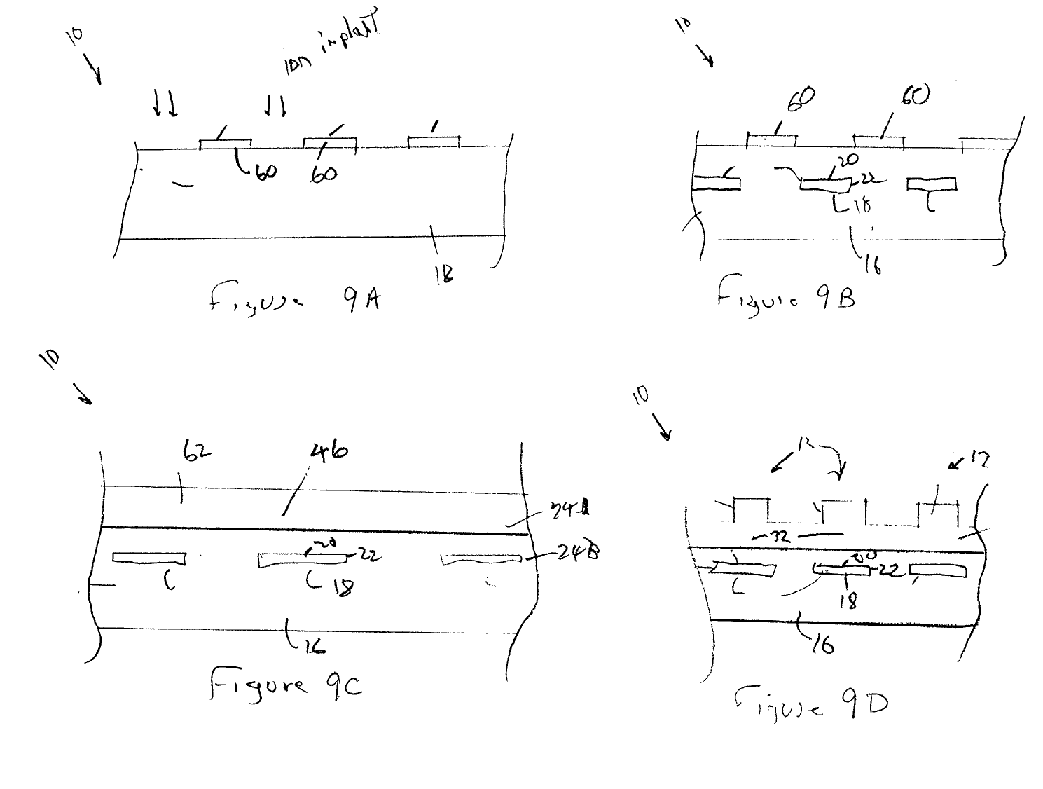

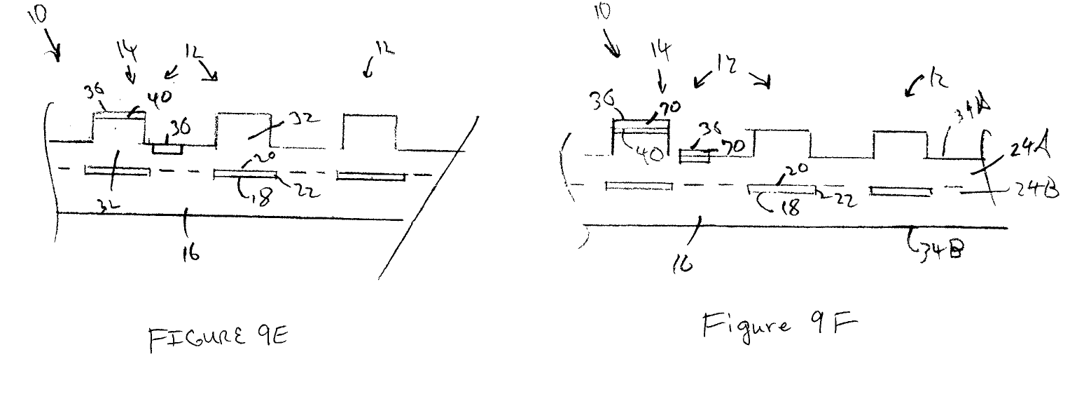

FIG. 9A-FIG. 9F illustrate a method for fabricating a component 10 having an attenuator 14. Although the components 10 shown above have only an attenuator 14, the method illustrated in FIG. 9A through FIG. 9F shows fabrication of a component 10 having a plurality of waveguides 12 that each have an attenuator in conjunction with a waveguide without an attenuator 14. Components having a plurality of waveguides that each include an attenuator are often desirable. For instance, each of the output waveguides on a demultiplexer can include an attenuator. The illustrated method can be adapted for fabrication of a component 10 having only an attenuator 14.

FIG. 9A shows a plurality of masks 60 formed on a substrate 16. Suitable substrates 16 include, but are not limited to, silicon substrates. The masks 60 are formed over regions of the substrate 16 where it is not desired to have a light barrier 18 formed. An ion implantation such as an O₂ ion implantation is performed. After high temperature annealing, a light barrier 18 is formed between the masks 60 as shown in FIG. 9B. When the ion implant is an O₂ ion implant and the substrate 16 is a silicon substrate 16, the annealing forms silicon dioxide light barriers 18. The masks 60 are removed and a light transmitting medium 62 such as silicon is grown on the substrate 16 as shown in FIG. 9C. A mask is formed over the portions of the light transmitting medium where it is desired to form waveguides 12. An etch is performed and the masks removed to provide the ridge shown on the component 10 of FIG. 9D. In some instances, the etch is performed so as to provide ridges having a height greater than 2 μm, greater than 4 μm, greater than 6 μm, greater than 8 μm, greater than 10 mm, greater than 12 μm, greater than 14 μm or greater than 16 μm. In some instances, there is no need to use the light transmitting medium 62 shown in FIG. 9C and the substrate 16 can be etched so as to form waveguides 12.

The component 10 of FIG. 9D is masked so that the portion(s) of the component 10 where the region(s) 40 of N type material is to be formed are exposed. The exposed portions are doped with an N type impurity. The mask is removed and the component 10 is re-masked so that the portion(s) of the component 10 where the region 40 of P type material is to be formed are exposed. The exposed portions are doped with a P type impurity. The masks are removed to provide the component 10 illustrated in FIG. 9E. Although the region 40 of N type material is described as being formed before the region 40 of P type material, the order of formation can be reversed. Further, other methods of forming the regions 40 of N type material and P type material can be employed. For instance, the P type and N type material can be formed by impurity diffusion. Additionally, the regions 40 of N type material can be formed by attaching a piece of N type material to the component 10 at the location the region 40 of N type material is desired. The regions of the P type material can be similarly formed. In some instances, the regions of N type material and/or P type material are formed to a concentration of 10^{Λ}(17-21)/cm³ at a thickness of less than 6 μm, 4 μm, 2 μm, 1 μm or 0.5 μm.

The component 10 of FIG. 9E is masked such that the regions 40 of N type material and the regions 40 of P type material are exposed. Index changing elements are positioned over the region 40 of N type material and the region 40 of P type material to provide the component 10 illustrated in FIG. 9F. When the index changing elements are electrical contacts, a metal layer can be formed over the region 40 of N type material and the region 40 of P type material. Suitable metals include, but are not limited to, Ni, Cr, Ti, Tungsten, Au, Ct, Pt, Al and/or their suicides. The metal layer can be formed to a thickness greater than 0.1 μm, 0.5 μm, 1 μm, 1.5 μm or 2 μm. The attenuator 14 of FIG. 9F is the attenuator 14 illustrated in FIG. 2A with the second light transmitting medium 24B, the first light transmitting medium 24A and the substrate 16 including the same material such as silicon.

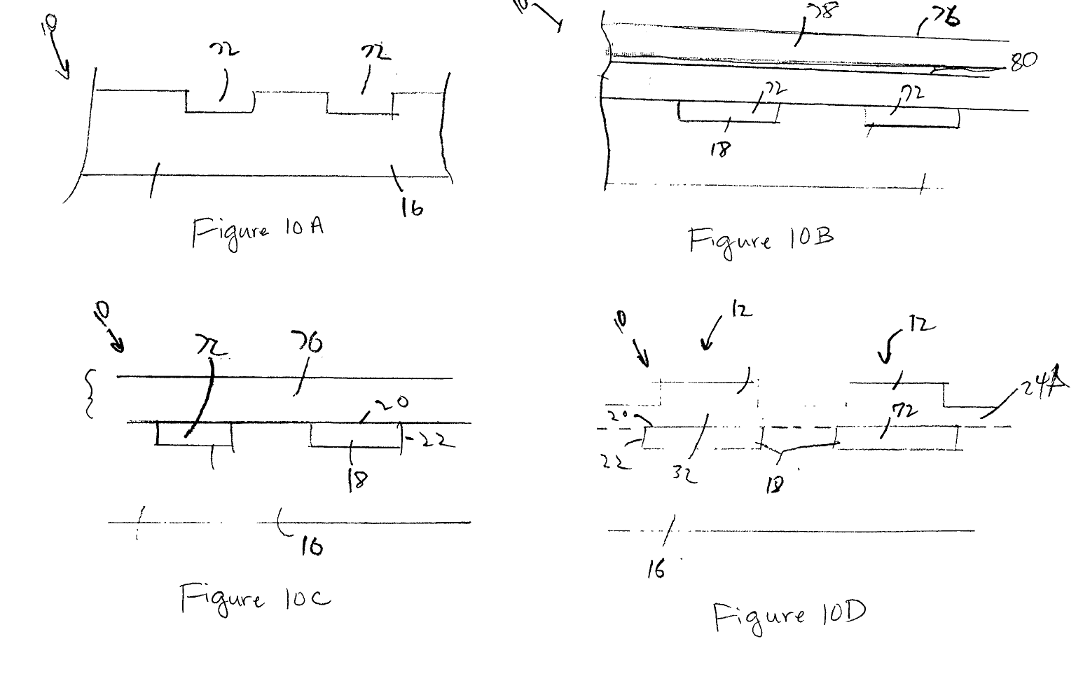

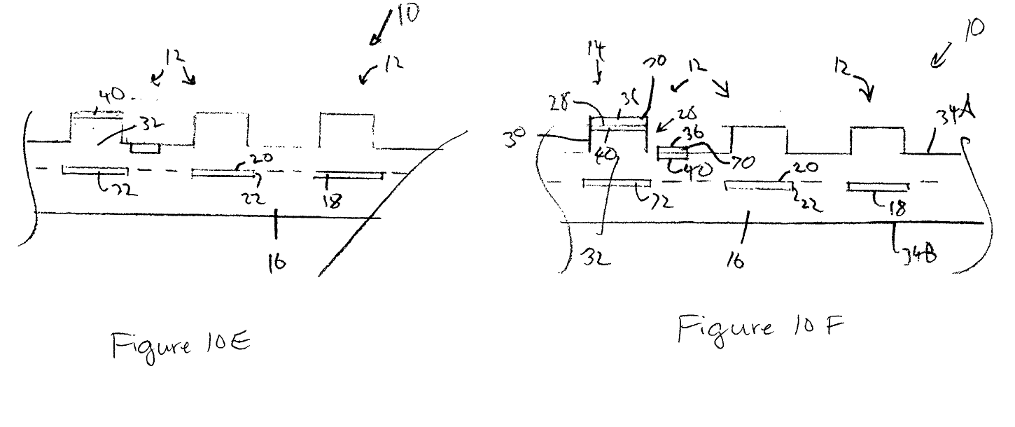

FIG. 10A through FIG. 10F illustrate a method for fabricating a component 10 having an attenuator 14. Although the components 10 shown above have only an attenuator 14, the method illustrated in FIG. 10A through FIG. 10F shows fabrication of a component 10 having a plurality of waveguides 12 in conjunction with the attenuator 14. The illustrated method can be adapted for fabrication of a component 10 having only an attenuator 14.

A mask and etch is performed on a substrate 16 such as a silicon substrate 16 to provide grooves 72 in the substrate 16 as illustrated in FIG. 10A. The light barriers 18 will be formed in the grooves 72. Air can be left in the grooves 72 or another light barrier 18 material can be deposited in the grooves. Chemical and Mechanical Planarization (CMP) techniques can be employed to remove the unwanted material outside the pocket and to smooth the light barrier. Wafer bonding techniques can then be applied to attach a light transmitting medium such as a silicon on insulator (SOI) wafer 76 to the substrate 16 as shown in FIG. 10B or to attach a silicon wafer 76 to the substrate 16 as shown in FIG. 10C. When a silicon on insulator wafer 76 is attached, the top silicon layer 78 and the silicon dioxide layer 80 are etched to provide the component 10 shown in FIG. 10C. The light transmitting medium can then be masked and etched to provide the ridges on the component 10 illustrated in FIG. 10D. In some instances, the etch is performed so as to provide ridges having a height greater than 2 μm, greater than 4 μm, greater than 6 μm, greater than 8 μm, greater than 10 mm, greater than 12 μm, greater than 14 μm or greater than 16 μm.

The component 10 of FIG. 10D is masked so that the portion(s) of the component 10 where the region 40 of N type material is to be formed are exposed. The exposed portions are doped with an N type impurity. The mask is removed and the component 10 is re-masked so that the portion(s) of the component 10 where the region 40 of P type material is to be formed are exposed. The exposed portions are doped with a P type impurity. The masks are removed to provide the component 10 illustrated in FIG. 10E. Although the region 40 of N type material is described as being formed before the region 40 of P type material, the order of formation can be reversed. Further, other methods of forming the regions 40 of N type material and P type material can be employed. For instance, the region 40 of N type material can be formed either by impurity diffusion or diffusion in a vacuum or by attaching a piece of N type material to the component 10 at the location the region 40 of N type material is desired. In some instances, the regions of N type material and/or P type material are formed to a concentration of 10^{Λ}(17-21)/cm³ at a thickness of less than 6 μm, 4 μm, 2 μm, 1 μm or 0.5 μm.

The component 10 of FIG. 10E is masked such that the regions 40 of N type material and the regions 40 of P type material are exposed. Index changing elements are positioned over the region 40 of N type material and the region 40 of P type material to provide the component 10 illustrated in FIG. 10F. When the index changing elements are electrical contacts, a metal layer can be formed over the region 40 of N type material and the region 40 of P type material. Suitable metals include, but are not limited to, Ni, Cr, Ti, W(Tungsten), Au, Cu, Pt, Al and/or their suicides. The metal layer can be formed to a thickness greater than 0.1 μm, 0.5 μm, 1 μm, 1.5 μm or 2 μm. The attenuator 14 of FIG. 10F is the attenuator 14 illustrated in FIG. 2A with the second light transmitting medium 24B, the first light transmitting medium 24A and the substrate 16 including the same material such as silicon.

When the index changing element is based on changing the temperature of the light transmitting medium, an N-type material and a P-type material are optional. Accordingly, the index changing element can be bonded to a component formed by the above methods before formation of the N-type material and/or the P-type material.

The methods described above require an etch that forms the sides of the ridge. The etch preferably provides smooth sides. Suitable etches include, but are not limited to, reactive ion etches, the Bosch process and the methods taught in U.S. patent application Ser. No. (not yet assigned); filed on Oct. 16, 2000; and entitled “Formation of a Smooth Vertical Surface on an Optical Component” which is incorporated herein in its entirety.

In many of the embodiments illustrated above, the drain is illustrated adjacent to each side 22 of the light barrier 18. However, a drain may be formed adjacent to only one side 22 of the light barrier 18. When the drain is formed adjacent to only one side 22 of the light barrier 18 and one index changing element 36 is positioned adjacent to a side 30 of a ridge 26, the drain is preferably formed on the side 30 of the ridge 26 which is not adjacent to the index changing element 36.

Additionally, an attenuator according to the present invention can include a variety of different light barriers although many of the embodiments above illustrate a light transmitting medium positioned adjacent to sides of a light barrier. For instance, the light barrier can extend across the entire component or extend under more than one waveguide as illustrated in FIG. 5A through FIG. 6B.

Although the index changing element 36 shown adjacent to the side of the ridge above are shown spaced apart from the side 30 of the ridge 26, the index changing elements 36 can be moved closer to the ridge and in some instances can be in contact with the ridge 26.

Although many of the above embodiments are illustrated as having index changing elements positioned adjacent to doped regions, the doped regions are optional in the above embodiments as attenuation can be achieved without the doped regions.

The invention can be extended to other waveguide types such as channel waveguides, rib waveguides, buried waveguides, diffused waveguides, slab waveguides, fibers and others.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. An optical attenuator, comprising:
a light transmitting medium having a ridge defining at least a portion of a light signal carrying region; and
at least one first index changing element positioned over the ridge, the at least one first index changing element for changing the index of refraction of the light transmitting medium.

2. The attenuator of claim 1, further comprising:
at least one second index changing element positioned adjacent to a side of the ridge.

3. The attenuator of claim 2, wherein the second index changing elements is spaced apart from the side of the ridge.

4. The attenuator of claim 2, further comprising:
at least one second index changing elements positioned under the ridge.

5. The attenuator of claim 1, wherein the light signal carrying region is at least partially defined by the ridge and a light barrier having a surface between two sides.

6. The attenuator of claim 5, wherein a second light transmitting medium is positioned adjacent to the sides of the light barrier.

7. The attenuator of claim 6, wherein the light transmitting medium and the second light transmitting medium are the same material.

8. The attenuator of claim 6, wherein the light barrier is sized such that the second light transmitting medium positioned adjacent to the sides of the light barrier receives at least a portion of a light signal that is reflected out of the light signal carrying region by changing the index of refraction of the light transmitting medium.

9. The attenuator of claim 1, wherein at least one of the first index changing elements is positioned adjacent to a region having a material selected from an N-type material and a P-type material.

10. The attenuator of claim 1, wherein at least one of the first index changing elements is an electrical contact.

11. The attenuator of claim 1, wherein at least one of the first index changing elements is a temperature changing element.

12. The attenuator of claim 1, wherein the ridge has a height of at least 5 μm.

13. An optical attenuator, comprising:
a waveguide formed over a substrate; and
at least one first index changing element positioned over the waveguide, the at least one first index changing element for changing the index of refraction of the light transmitting medium.

14. The attenuator of claim 13, further comprising:
at least one second index changing element positioned adjacent to a side the waveguide.

15. The attenuator of claim 14, further comprising:
at least one second index changing elements positioned opposite the waveguide and under the substrate.

16. The attenuator of claim 13, wherein the attenuator includes a light transmitting medium positioned over the substrate, the light transmitting medium including a ridge that defines a portion of a light signal carrying region of the waveguide.

17. The attenuator of claim 16, wherein the attenuator includes a light barrier positioned between the light transmitting medium and the substrate, the light barrier having a surface that defines a portion of the light signal carrying region, the surface positioned between sides and a second light transmitting medium positioned adjacent to the sides of the light barrier.

18. The attenuator of claim 17, wherein the light transmitting medium and the second light transmitting medium are the same material.

19. The attenuator of claim 13, wherein the at least one first index changing element is centered relative to the waveguide.

20. An optical attenuator, comprising:
a light signal carrying region defined in a light transmitting medium, the light signal carrying region having one or more sides extending along a longitudinal length of the light signal carrying region; and
two or more index changing elements positioned adjacent to the same side of the light signal carrying region, the index changing elements configured to change the index of refraction of the light transmitting medium.

21. The attenuator of claim 20, wherein at least one side of the light signal carrying region is a side of a ridge.

22. The attenuator of claim 20, wherein at least one index changing elements is positioned between the side and another index changing element.

23. The attenuator of claim 20, wherein at east two of the index changing elements is substantially equidistant from the side.

24. The attenuator of claim 20, wherein the light signal carrying region is at least partially defined by a light barrier that includes a surface between two sides.

25. The attenuator of claim 24, wherein a second light transmitting medium is positioned adjacent to the sides of the light barrier.

26. The attenuator of claim 25, wherein the light barrier is sized such that the second light transmitting medium receives at least a portion of a light signal that is reflected out of the light signal carrying region by changing the index of refraction of the light transmitting medium.

27. The attenuator of claim 20, wherein at least one of the index changing elements is positioned adjacent to a region having a material selected from an N-type material and a P-type material.

28. An optical attenuator, comprising:
a light barrier having a surface between sides, the surface of the light barrier defining a portion of a light signal carrying region in a first light transmitting medium positioned adjacent to the surface of the light barrier;
a second light transmitting medium adjacent to the sides of the light barrier; and
at least one index changing element for changing the index of refraction of the first light transmitting medium such that at least a portion of a light signal is diverted from the light signal carrying region.

29. The attenuator of claim 28, wherein the first light transmitting medium is the same material as the second light transmitting medium.

30. The attenuator of claim 29, wherein the first light transmitting medium includes a ridge that defines a portion of the light signal carrying region.

31. The attenuator of claim 30, wherein at least one first index changing element is positioned over the ridge.

32. The attenuator of claim 31, wherein at least one second index changing element is positioned adjacent to a lateral side of the ridge.

33. The attenuator of claim 31, wherein at least one second index changing element is positioned under the ridge.

34. The attenuator of claim 30, wherein the ridge includes at least two lateral sides and at least two index changing elements are positioned adjacent to the same lateral side of the ridge.

35. A method for forming an optical attenuator, comprising:
obtaining a light transmitting medium having a ridge that defines at least a portion of a light signal carrying region in the light transmitting medium; and
positioning at least one first index changing element over the ridge, the at least one first index changing element for changing the index of refraction of the light transmitting medium.

36. The method of claim 35, further comprising:
positioning at least one second index changing element positioned adjacent to a lateral side of the ridge.

37. The method of claim 36, wherein the second index changing elements is spaced apart from the side of the ridge.

38. The method of claim 35, further comprising:
positioning at least one second index changing element under the ridge.

39. The method of claim 35, wherein the light transmitting medium is produced such that the light transmitting medium is adjacent to a light barrier that defines at least a portion of the light signal carrying region in the light transmitting medium.

40. The method of claim 39, wherein the light barrier includes a surface between two sides and a second light transmitting medium is positioned adjacent to the sides of the light barrier.

41. The method of claim 40, wherein the light transmitting medium and the second light transmitting medium are the same material.

42. The method of claim 35, positioning the at least one first index changing element over the ridge includes
positioning the at least one first index changing element over a region having a material selected from an N-type material and a P-type material.

43. The method of claim 35, wherein the ridge has a height of at least 5 μm.

44. A method of forming an optical component, comprising:
obtaining a light transmitting medium having a light signal carrying region with sides extending along a longitudinal length of the light signal carrying region; and
positioning two or more index changing elements adjacent to the same side of the light signal carrying region, the two or more index changing elements configured to change the index of refraction of the light transmitting medium.

45. The method of claim 44, wherein at least one side of the light signal carrying region is a side of a ridge.

46. The method of claim 44, wherein at least one index changing elements is positioned between the side and another index changing element.

47. The method of claim 44, wherein at east two of the index changing elements are substantially equidistant from the side.

48. The method of claim 44, wherein the light signal carrying region is at least partially defined by a light barrier that includes a surface between two sides.

49. The method of claim 48, wherein a second light transmitting medium is positioned adjacent to the sides of the light barrier.

50. The method of claim 44, wherein positioning two or more index changing elements adjacent to the same side of the light signal carrying region includes
positioning at least one of the index changing elements adjacent to a region of the light transmitting medium having a material selected from an N-type material and a P-type material.

51. A method of forming an optical attenuator, comprising:
obtaining a first light transmitting medium having a light signal carrying region with a surface between sides, the first light transmitting medium produced such that the first light transmitting medium is adjacent to the surface of the light barrier and a second light transmitting medium is adjacent to at least one side of the light barrier; and
positioning at least one index changing element such that light signals are diverted from the light signal carrying region in response to operating the at least one index changing element so as to change the index of refraction of the first light transmitting medium.

52. The method of claim 51, wherein the first light transmitting medium is the same material as the second light transmitting medium.

53. The method of claim 51, wherein the first light transmitting medium includes a ridge that defines a portion of the light signal carrying region.

54. The method of claim 53, wherein the at least one index changing element is positioned over the ridge.

55. The method of claim 53, wherein at least one index changing element is positioned adjacent to a lateral side of the ridge.

56. The method of claim 53, wherein at least one index changing element is positioned under the ridge.

57. The method of claim 51, wherein the ridge includes at least two lateral sides and at least two index changing elements are positioned adjacent to the same lateral side of the ridge.

58. A method of forming an optical attenuator, comprising:
obtaining an optical component having a waveguide formed over a substrate; and
forming at least one first index changing element over the waveguide, the at least one first index changing element for changing the index of refraction of the light transmitting medium.

59. The attenuator of claim 58, further comprising:
forming at least one second index changing element positioned adjacent to a side the waveguide.

60. The attenuator of claim 58, further comprising:
forming at least one second index changing elements positioned opposite the waveguide and under the substrate.
